(19) United States
(12) Patent Application Publication
(10) Pub. No.: US 2004/0141315 A1
(43) Pub. Date: Jul. 22, 2004

(54) Flameless candle

(76) Inventor: Glenn Sherburne, Albert Lea, MN (US)

Correspondence Address: John Vasuta, Esq., Po Box 1151, Hudson, OH, 44236, US

(21) Appl. No.: 10/620,276

(22) Filed: Jul. 14, 2003

Related U.S. Application Data
(60) Provisional application No. 60/395,054, filed on Jul. 12, 2002.
(60) Provisional application No. 60/440,739, filed on Jan. 18, 2003.

(51) Int. Cl. F21L 19/00

(52) U.S. Cl. 362/161

(57) ABSTRACT

A candle including a light positioned within an internal cavity in the candle for providing bright illumination to the translucent candle. The candle more specifically includes an insert with a light emitting diode or incandescent bulb therein as well as a battery and a circuit board as well as a device for causing flickering of the light.

### PRIORITY REFERENCE

This patent application claims priority from both provisional patent applications: 60/395,054 filed Jul. 12, 2002 and 60/440,739 filed Jan. 18, 2003.

### BACKGROUND OF THE INVENTION

1. Technical Field

The present invention relates to candles, and more particularly is a flameless candle illuminated by an internal illumination source not incorporating an open flame. Specifically, the invention is a translucent candle with an internal cavity including a light source such as a light emitting diode or incandescent bulb, a power source, and any necessary circuitry including light flickering circuitry.

2. Background Information

Candles of a wax construction have been made and used for many centuries. Generally, a candle comprises an ignitable and burnable wick surrounded by a wax structure that slowly burns away. These candles have been used over the centuries to provide light, and in more recent years for aesthetic purposes such as mood lighting, accent lighting or the like.

The wicks on candles also often cause uneven burning of the candle body, or merely illumination of the top portion of the candle.

It is well known that the burning of candles involves inherent risk of fire due to the open flame. The burning wick may ignite surrounding flammable objects such as draperies, furniture or the like. In addition, candle users have a tendency to forget about a slow burning candle, thereby increasing the risk of fire where such candle is left un-attended.

It is thus desirable to provide a candle that reduces or removes these risks and undesirable features.

### SUMMARY OF THE INVENTION

The present invention is a candle that overcomes these and other limitations. The present invention is specifically a candle including a wax body with an internal cavity therein, a light positioned within the internal cavity for illuminating the wax body from within, a power source coupled to the light, and flickering circuitry to allow the light to flicker.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a view of a typical candle illuminated at the top end;

FIG. 2 is a view of the candle of the present invention illuminated from within;

FIG. 3 is a cross sectional view of one embodiment of the candle with an insert therein for providing illumination;

FIG. 4 is a front side view of the one half of the capsule body including the light that is insertable within the candle;

FIG. 5 is a right side view of the body of FIG. 4;

FIG. 6 is a back side view of the body of FIG. 4;

FIG. 7 is a left side view of the body of FIG. 4;

FIG. 8 is a bottom view of the body of FIG. 4;

FIG. 9 is a detail taken from FIG. 6;

FIG. 10 is a right side view of the insert of FIG. 4;

FIG. 11 is a front side view of the body of FIG. 10;

FIG. 12 is a left side view of the body of FIG. 10;

FIG. 13 is a back side view of the body of FIG. 10; and

FIG. 14 is a top view of the body of FIG. 10.

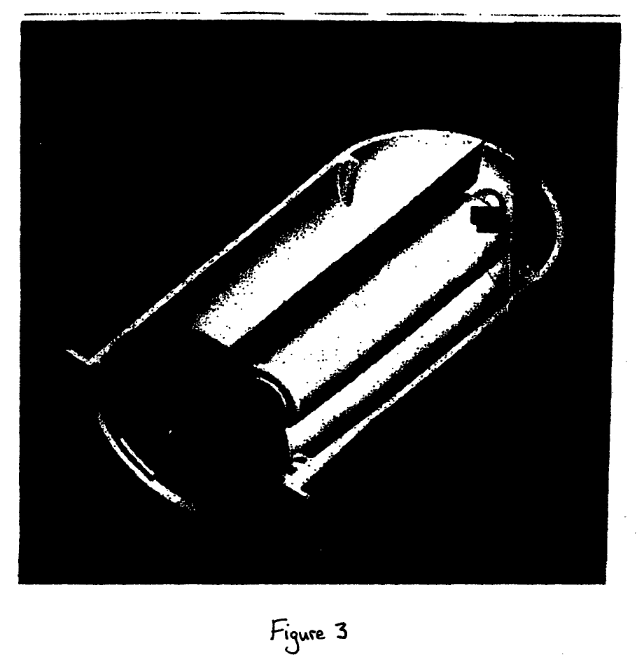

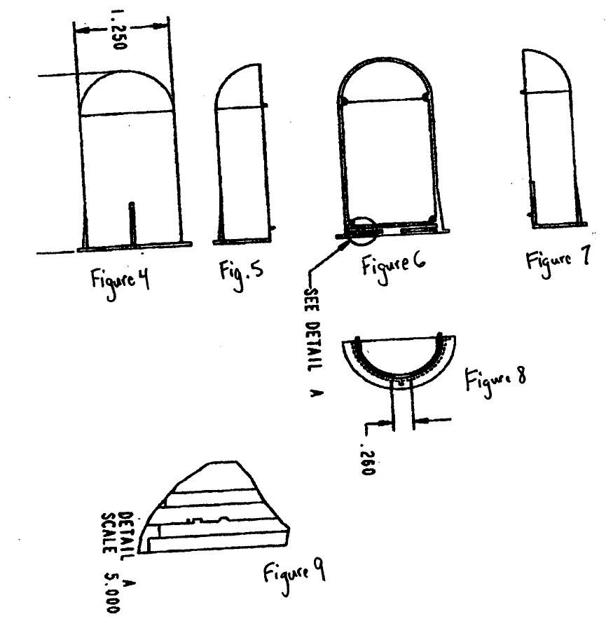

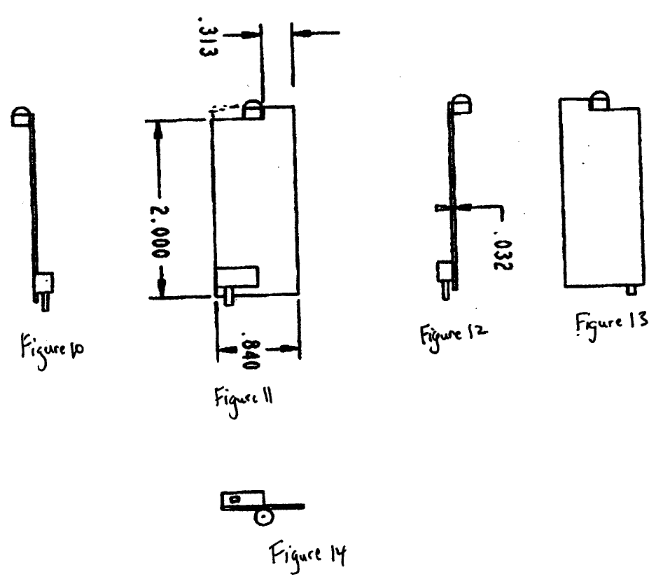

Similar numerals refer to similar parts throughout the drawings.

### DESCRIPTION OF THE PREFERRED EMBODIMENT

The candle of the present invention is indicated generally at 10. The candle includes a wax body 12 with a hollow cavity 14 therein in which an insert 16 is selectively positionable. The insert 16 includes a bright light source 20, and a power source 22 with some form of an on-off switch 24.

In one embodiment, the light source 20 is an incandescent light bulb of a type that provides intense light.

In accordance with a preferred embodiment and one of the features of the invention, the light source 20 is a light emitting diode or LED which is a semiconductor diode that converts applied voltage to light. Light emitting diodes provide a significantly brighter light than other light sources while at the same time using substantially less energy from the power source and providing less heat to the surroundings in comparison to incandescent, halogen or other light sources. Light emitting diodes also provide a very consistent lighting.

The power source 22 may be any form of power sources including standard batteries, rechargeable batteries, or AC power provided by a cord from an outlet; however in the most desirable embodiment, the power source is standard batteries such as “A”, “AA” or “AAA” as are readily available. It has been found that LEDs when powered off of several standard “AA” batteries can provide two hundred or more hours of illumination. These batteries are then easily replaced as described below, thus eliminating the need for cords or recharging.

The use of a light emitting diode further necessitates the insert 16 include a circuit board 26 for controlling the light emitting diode 20. The circuit board 26 controls the voltage and/or amperage as needed.

In one embodiment as is shown in the Figures, the insert 16 is a capsule-like member that is translucent in nature, and includes a body 30 of one or more pieces (in this embodiment two pieces namely 30A and 30B), and a removeable end cap 32 defining a readily accessible internal chamber 34 in which the light 20, battery or batteries 22, and the circuit board 26 are located. Preferably, the switch 24 extends through the end cap 32 to provide for easy access thereto.

This body 30 protects the circuit board and LED, as well as minimizes the transfer of heat from the light to the candle. This minimizes or insulating protects the candle from melting or other distortion from the internal light source. The body 30 further protects the circuit board, light and battery from the candle melting onto or over these parts where the candle is subject to undesirable external heat such as the sun.

The candle need not in desirably does not include a standard burnable wick thereby prohibiting accidental burning of this candle.

One specific embodiment is disclosed in the Figures. The capsule-like member that is translucent in nature is specifically an elongated cylindrical-like structure with a semi-hemispherical top end and an open bottom end with internal chamber 34 therein. The semi-hemispherical top end of the elongated cylindrical-like structure may be two pieces 30A and 30B as shown that are snapped, adhered or otherwise affixed together.

A cap 32 with a functional yet inconspicuous handle 38 is preferably positionable within the open bottom end whereby it selectively locks in place due to outwardly extending nubs 40 on the cap interacting with inwardly extending nubs 42 on the surface defining the open bottom end—this allows for a locked and unlocked position depending upon the rotational position of the cap in relation to the open bottom end.

In one embodiment, the circuit board 26 includes the light 20 and battery or batteries 22 seated on or connected thereto, whereby the switch 24 extends from the board 26 through the end cap 32 to provide for easy access thereto.

Where a more realistic flickering type look is desired, the candle 10 includes a device or circuit for varying the voltage or current to the light 20 with such a device or circuit being referred hereafter to as a flickering means. Example of such a flickering means include an oscillator such as a 555 timer, or a microcontroller such as a 4, 8, 16 or 32 bit type where the microcontroller may be programmed to provide various lighting effect such as random lighting (since a candle typically has a random variation in its intensity), or flashing or patterned lighting. In any case, the flickering means are a way to alter the voltage or current to the light 20 thereby causing changes in the light's intensity.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

We claim:

1. A candle comprising:
a wax body with an internal cavity therein;
an intense light positioned within the internal cavity for illuminating the wax body from within;
a power source coupled to the light emitting diode; and
flickering means for causing the light to flicker.

2. The candle of claim 1 wherein the intense light is one of a light emitting diode and an incandescent light.

3. The candle of claim 2 further comprising a circuit board for controlling the voltage from the power source to the light emitting diode whereby the circuit board includes as flickering means a device capable of time variation of the current or voltage.

4. The candle of claim 3 wherein the power source is a battery.

5. The candle of claim 3 wherein the light emitting diode, power source and circuit board are positioned within the internal cavity.

6. The candle of claim 5 wherein the wax body includes a substantially flat bottom surface with the internal cavity extending therefrom.

7. The candle of claim 6 wherein the light emitting diode, power source and circuit board are contained in an enclosed insert positioned within the internal cavity.

8. The candle of claim 7 wherein the enclosed insert is a translucent material.

9. The candle of claim 8 wherein the enclosed insert is affixed within the internal cavity and includes a door for access to the power source which is replaceable.

10. The candle of claim 9 wherein the enclosed insert is of a cylindrical shape with a top end of a semi-hemispherical shape and a bottom flat end planar with the flat bottom surface of the wax body.

11. The candle of claim 10 wherein the bottom flat end defines an access hole in which the door is positioned where the access hole includes intermittent radially inwardly extending lips that selectively hold the door in place via corresponding intermittent planarly outward extending tabs on the door.

12. The candle of claim 3 wherein the power source lasts at least one hundred continuous hours of illumination.

13. The candle of claim 3 wherein the power source lasts at least two hundred continuous hours of illumination.

14. The candle of claim 1 wherein the flickering means is one of an oscillator and a programmable microcontroller.

15. The candle of claim 14 wherein the flickering means varies the voltage or the current over time.

16. The candle of claim 14 wherein the oscillator is a 555 timer.

17. The candle of claim 14 wherein the programmable microcontroller is programmed to provide random lighting.

18. The candle of claim 14 wherein the programmable microcontroller is programmed to provide flashing lighting.

19. The candle of claim 14 wherein the programmable microcontroller is programmed to provide patterned lighting.

20. A candle comprising:
a wax body with an internal cavity therein;
a light source positioned within the internal cavity for illuminating the wax body from within;
a disposable battery positioned within the internal cavity and coupled to the light source; and
flickering means capable of time variation of at least one of current and voltage provided to the light source.

21. The candle of claim 20 further comprising a circuit board having the flickering means thereon, the circuit board for controlling the voltage from the battery to the light source.

22. The candle of claim 21 wherein the wax body includes a substantially flat bottom surface with the internal cavity extending therefrom, and wherein the light source, battery and circuit board are contained in an enclosed insert positioned within the internal cavity.

23. The candle of claim 22 wherein the enclosed insert is a translucent material.

24. The candle of claim 23 wherein the enclosed insert is of a cylindrical shape with a top end of a semi-hemispherical shape and a bottom flat end planar with the flat bottom surface of the wax body and including a door therein for providing access to the battery and light source.

25. The candle of claim 20 wherein the bright light source is a light emitting diode.
